(19) United States
(12) Patent Application Publication
(10) Pub. No.: US 2009/0270259 A1
(43) Pub. Date: Oct. 29, 2009

(54) Novel Agrochemical Formulations

(75) Inventors: Helmut Auweter, Limburgerhof (DE); Sven Holger Behrens, Atlanta, GA (US); To Ngai, Hong Kong (CN)

Correspondence Address: BRINKS, HOFER, GILSON & LIONE, P.O. BOX 1340, MORRISVILLE, NC, 27560, US

(73) Assignee: BASF SE, Ludwigsshafen (DE)

(21) Appl. No.: 12/067,530

(22) PCT Filed: Sep. 14, 2006
(86) PCT No.: PCT/EP06/66341

§ 371 Date: Mar. 20, 2008

(30) Foreign Application Priority Data
Sep. 23, 2005 (EP) 05020749.7

(51) Int. Cl. A01N 25/28; A01P 3/00; A01P 7/04; A01P 13/00

(52) U.S. Cl. 504/359; 424/497; 514/772.3

(57) ABSTRACT

The present invention comprises methods for producing a formulation with controlled active substance release, wherein a Pickering emulsion of the solvent in water type is applied to a solid carrier, and also formulations with controlled active substance release producible by the abovementioned method.

The present invention comprises methods for producing a formulation with controlled active substance release, wherein a Pickering emulsion of the solvent in water type is applied to a solid carrier, and also formulations with controlled active substance release producible by the abovementioned method.

Environmental influences such as wind, sun, rain, but also groundwater may bring about undesired distribution of crop protection active substances. As a result, the amount of active substance can be reduced to such a degree that subsequent infestation of harmful organisms or subsequent growth of undesired plants cannot be prevented.

Formulations with controlled active substance release circumvent these problems by releasing certain amounts of active substance in a delayed manner over a certain period.

In this connection, it is desirable to achieve the most efficient release rate possible.

It was therefore an object of the present invention to provide formulations which have controlled active substance release and in which some of the active substance is available directly and some of the active substance is released in a delayed manner.

The object was achieved as follows:

Surprisingly, it has been found that Pickering emulsions of the solvent in water type in which
(i) an agrochemical active substance is dissolved or dispersed in the solvent droplets and
(ii) a polymer in particulate form is used as emulsifier
   are suitable for producing formulations with an efficient release rate.

In Pickering emulsions, good coalescence protection is achieved by incorporating solids particles into the phase interface of the emulsion. It is a prerequisite for the formation of stable emulsions that the solid is wetted by oil phase and water phase.

Pickering emulsions for cosmetic and dermatological purposes are described, for example, in EP-A 987008.

WO 2004/096422 discloses Pickering emulsions for a large number of applications, where the particulate emulsifiers with which emulsions are stabilized, with appropriate selection of the parameters, lead to the emulsions being able to be broken or phase-inverted.

The fact that Pickering emulsions of the solvent in water type in which
(i) an agrochemical active substance is dissolved or dispersed in the solvent droplets and
(ii) a polymer in particulate form is used as emulsifier
   are suitable, by fusing the polymer particles, for producing agrochemical formulations with controlled active substance release, in particular for the dressing of seed material, is not evident from the prior art.

The term agrochemical active substance/pesticide refers here to at least one active substance selected from the group of insecticides, fungicides, herbicides and/or safeners, growth regulators (see Pesticide Manual, 13th Ed. (2003)). In this connection, it is also possible to use combinations of two or more of the active substances specified below.

The following list of insecticides indicates possible active substances, but should not be limited to these:

A.1. Organo(thio)phosphates: acephate, azamethiphos, azinphos-methyl, chlorpyrifos, chlorpyrifos-methyl, chlorfenvinphos, diazinon, dichlorvos, dicrotophos, dimethoate, disulfoton, ethion, fenitrothion, fenthion, isoxathion, malathion, methamidophos, methidathion, methyl-parathion, mevinphos, monocrotophos, oxydemeton-methyl, paraoxon, parathion, phenthoate, phosalone, phosmet, phosphamidon, phorate, phoxim, pirimiphos-methyl, profenofos, prothiofos, sulprophos, tetrachlorvinphos, terbufos, triazophos, trichlorfon;
A.2. Carbamates: alanycarb, aldicarb, bendiocarb, benfuracarb, carbaryl, carbofuran, carbosulfan, fenoxycarb, furathiocarb, methiocarb, methomyl, oxamyl, pirimicarb, propoxur, thiodicarb, triazamate;
A.3. Pyrethroids: allethrin, bifenthrin, cyfluthrin, cyhalothrin, cyphenothrin, cypermethrin, alpha-cypermethrin, beta-cypermethrin, zeta-cypermethrin, deltamethrin, esfenvalerate, etofenprox, fenpropathrin, fenvalerate, imiprothrin, lambda-cyhalothrin, gamma-cyhalothrin, permethrin, prallethrin, pyrethrin I and II, resmethrin, silafluofen, tau-fluvalinate, tefluthrin, tetramethrin, tralomethrin, transfluthrin;
A.4. Growth regulators: a) chitin synthesis inhibitors: benzoylureas: chlorfluazuron, cyramazin, diflubenzuron, flucycloxuron, flufenoxuron, hexaflumuron, lufenuron, novaluron, teflubenzuron, triflumuron; buprofezin, diofenolan, hexythiazox, etoxazole, clofentazine; b) ecdysone antagonists: halofenozide, methoxyfenozide, tebufenozide, azadirachtin; c) juvenoids: pyriproxyfen, methoprene, fenoxycarb; d) lipid biosynthesis inhibitors: spirodiclofen, spiromesifen, a tetronic acid derivative of formula Γ¹,

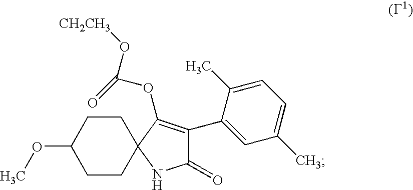

A.5. Nicotine receptor agonists/antagonists: clothianidin, dinotefuran, imidacloprid, thiamethoxam, nitenpyram, acetamiprid, thiacloprid;
A.6. GABA antagonists: acetoprole, endosulfan, ethiprole, fipronil, vaniliprole;
A.7. Macrolide insecticides: abamectin, emamectin, milbemectin, lepimectin, spinosad;
A.8. METI I acaricides: fenazaquin, pyridaben, tebufenpyrad, tolfenpyrad;
A.9. METI II and III compound: acequinocyl, fluacyprim, hydramethylnon;
A.10. Uncoupler compounds: chlorfenapyr;
A.11. Inhibitors of oxidative phosphorylation: cyhexatin, diafenthiuron, fenbutatin oxide, propargite;
A.12. Molting disrupter compounds: cryomazine;
A.13. Inhibitors of mixed function oxidase: piperonyl butoxide;
A.14. Sodium channel blockers: indoxacarb, metaflumizone;
A.15. Various: benclothiaz, bifenazate, cartap, flonicamid, pyridalyl, pymetrozine, sulfur, thiocyclam and aminoisothiazole compounds of formula Γ²,

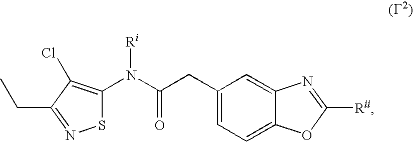

where Rⁱ is —CH₂OCH₂CH₃ or H and Rⁱⁱ is CF₂CF₂CF₃ or CH₂CH(CH₃)₃, anthranilamide compounds of formula Γ³

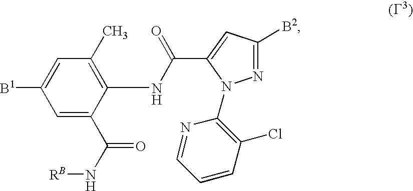

where B¹ is hydrogen or chlorine, B² is bromine or CF₃, and R^{B} is CH₃ or CH(CH₃)₂, and malononitrile compounds as described in JP 2002 284608, WO 02/89579, WO 02/90320, WO 02/90321, WO 04/06677, WO 04/20399, or JP 2004 99597, N—R′-2,2-dihalo-1-R′cyclo-propanecarboxamide-2-(2,6-dichloro-α,α,α,α-tri-fluoro-p-tolyl)hydrazone or N—R′-2,2-di(R′″)propionamide-2-(2,6-dichloro-α,α,α,α-trifluoro-p-tolyl)hydrazone, in which R′ is methyl or ethyl, halo is chlorine or bromine, R″ is hydrogen or methyl and R′″ is methyl or ethyl.

The following list of fungicides indicates possible active substances but should not be limited to these:

### 1. Strobilurins

azoxystrobin, dimoxystrobin, enestroburin, fluoxastrobin, kresoxim-methyl, metominostrobin, picoxystrobin, pyraclostrobin, trifloxystrobin, orysastrobin, methyl (2-chloro-5-[1-(3-methylbenzyloxyimino)ethyl]benzyl)carbamate, methyl (2-chloro-5-[1-(6-methylpyridin-2-ylmethoxyimino)ethyl]benzyl)carbamate, methyl 2-(ortho((2,5-dimethylphenyloxymethylene)phenyl)-3-methoxyacrylate;

### 2. Carboxamides

carboxanilides: benalaxyl, benodanil, boscalid, carboxin, mepronil, fenfuram, fenhexamid, flutolanil, furametpyr, metalaxyl, ofurace, oxadixyl, oxycarboxin, penthiopyrad, thifluzamide, tiadinil, N-(4′-bromobiphenyl-2-yl)-4-difluoromethyl-2-methylthiazole-5-carboxamide, N-(4′-trifluoromethylbiphenyl-2-yl)-4-difluoromethyl-2-methylthiazole-5-carboxamide, N-(4′-chloro-3′-fluorobiphenyl-2-yl)-4-difluoromethyl-2-methylthiazole-5-carboxamide, N-(3′,4′-dichloro-4-fluorobiphenyl-2-yl)-3-difluoromethyl-1-methylpyrazole-4-carboxamide, N-(2-cyanophenyl)-3,4-dichloroisothiazole-5-carboxamide;
carboxylic acid morpholides: dimethomorph, flumorph;
benzoamides: flumetover, fluopicolide (picobenzamid), zoxamide;
other carboxamides: carpropamid, diclocymet, mandipropamid, N-(2-(4-[3-(4-chlorophenyl)prop-2-inyloxy]-3-methoxyphenyl)ethyl)-2-methanesulfonylamino-3-methylbutyramide, N-(2-(4-[3-(4-chlorophenyl)prop-2-inyloxy]-3-methoxyphenyl)ethyl)-2-ethanesulfonylamino-3-methylbutyramide;

### 3. Azoles

triazoles: bitertanol, bromuconazole, cyproconazole, difenoconazole, diniconazole, enilconazole, epoxiconazole, fenbuconazole, flusilazole, fluquinconazole, flutriafol, hexaconazol, imibenconazole, ipconazole, metconazol, myclobutanil, penconazole, propiconazole, prothioconazole, simeconazole, tebuconazole, tetraconazole, triadimenol, triadimefon, triticonazole;
imidazoles: cyazofamid, imazalil, pefurazoate, prochloraz, triflumizole;
benzimidazoles: benomyl, carbendazim, fuberidazole, thiabendazole;
others: ethaboxam, etridiazole, hymexazole;

### 4. Nitrogen-Containing Heterocyclyl Compounds:

pyridines: fluazinam, pyrifenox, 3-[5-(4-chlorophenyl)-2,3-dimethylisoxazolidin-3-yl]pyridine;
pyrimidines: bupirimate, cyprodinil, ferimzone, fenarimol, mepanipyrim, nuarimol, pyrimethanil;
piperazines: triforine;
pyrrols: fludioxonil, fenpiclonil;
morpholines: aldimorph, dodemorph, fenpropimorph, tridemorph;
dicarboximides: iprodione, procymidone, vinclozolin;
others: acibenzolar-S-methyl, anilazin, captan, captafol, dazomet, diclomezine, fenoxanil, folpet, fenpropidin, famoxadone, fenamidone, octhilinone, probenazole, proquinazid, pyroquilon, quinoxyfen, tricyclazole, 5-chloro-7-(4-methylpiperidin-1-yl)-6-(2,4,6-trifluorophenyl)[1,2,4]triazolo[1,5-a]pyrimidine, 2-butoxy-6-iodo-3-propylchromen-4-one, N-dimethyl-3-(3-bromo-6-fluoro-2-methylindole-1-sulfonyl)[1,2,4]triazole-1-sulfonamide;

### 5. Carbamates and Dithiocarbamates

dithiocarbamates: ferbam, mancozeb, maneb, metiram, metam, propineb, thiram, zineb, ziram;
carbamates: diethofencarb, flubenthiavalicarb, iprovalicarb, propamocarb, methyl 3-(4-chlorophenyl)-3-(2-isopropoxycarbonylamino-3-methylbutyrylamino)propionate, 4-fluorophenyl N-(1-(1-(4-cyanophenyl)ethanesulfonyl)but-2-yl)carbamate;

### 6. Other Fungicides

guanidines: dodine, iminoctadine, guazatine;
antibiotics: kasugamycin, polyoxine, streptomycin, validamycin A;
organometallic compounds: fentin salts;
sulfur-containing heterocyclyl compounds: isoprothiolane, dithianon;
organophosphorus compounds: edifenphos, fosetyl, fosetyl aluminum, iprobenfos, pyrazophos, tolclofosmethyl, phosphorous acid and its salts;
organochlorine compounds: thiophanate methyl, chlorothalonil, dichlofluanid, tolylfluanid, flusulfamide, phthalide, hexachlorbenzene, pencycuron, quintozene;
nitrophenyl derivatives: binapacryl, dinocap, dinobuton;
inorganic active ingredients: Bordeaux broth, copper acetate, copper hydroxide, copper oxychloride, basic copper sulfate, sulfur;
others: spiroxamine, cyflufenamid, cymoxanil, metrafenone.

The following list of herbicides indicates possible active substances, but should not be limited to these:

compounds which inhibit the biosynthesis of lipids, for example chlorazifop, clodinafop, clofop, cyhalofop, ciclofop, fenoxaprop, fenoxaprop-p, fenthiaprop, fluazifop, fluazifop-P, haloxyfop, haloxyfop-P, isoxapyrifop, metamifop, propaquizafop, quizalofop, quizalofop-P, trifop, alloxydim, butroxydim, clethodim, cloproxydim, cycloxydim, profoxydim, sethoxydim, tepraloxydim, tralkoxydim, butylate, cycloat, diallat, dimepiperat, EPTC, esprocarb, ethiolate, isopolinate, methiobencarb, molinate, orbencarb, pebulate, prosulfocarb, sulfallat, thiobencarb, thiocarbazil, triallat, vernolat, benfuresat, ethofumesat and bensulid;
ALS inhibitors, such as amidosulfuron, azimsulfuron, bensulfuron, chlorimuron, chlorsulfuron, cinosulfuron, cyclosulfamuron, ethametsulfuron, ethoxysulfuron, flazasulfuron, flupyrsulfuron, foramsulfuron, halosulfuron, imazosulfuron, iodosulfuron, mesosulfuron, metsulfuron, nicosulfuron, oxasulfuron, primisulfuron, prosulfuron, pyrazosulfuron, rimsulfuron, sulfometuron, sulfosulfuron, thifensulfuron, triasulfuron, tribenuron, trifloxysulfuron, triflusulfuron, tritosulfuron, imazamethabenz, imazamox, imazapic, imazapyr, imazaquin, imazethapyr, cloransulam, diclosulam, florasulam, flumetsulam, metosulam, penoxsulam, bispyribac, pyriminobac, propoxycarbazone, flucarbazone, pyribenzoxim, pyriftalid and pyrithiobac;
compounds which inhibit the photosynthesis, such as atraton, atrazine, ametryne, aziprotryne, cyanazine, cyanatryn, chlorazine, cyprazine, desmetryne, dimethametryne, dipropetryn, eglinazine, ipazine, mesoprazine, methometon, methoprotryne, procyazine, proglinazine, prometon, prometryne, propazine, sebuthylazine, secbumeton, simazine, simeton, simetryne, terbumeton, terbuthylazine and terbutryne;
protoporphyrinogene-IX oxidase inhibitors, such as acifluorfen, bifenox, cchlomethoxyfen, chlornitrofen, ethoxyfen, fluorodifen, fluoroglycofen, fluoronitrofen, fomesafen, furyloxyfen, halosafen, lactofen, nitrofen, nitrofluorfen, oxyfluorfen, fluazolate, pyraflufen, cinidon-ethyl, flumiclorac, flumioxazin, flumipropyn, fluthiacet, thidiazimin, oxadiazon, oxadiargyl, azafenidin, carfentrazone, sulfentrazone, pentoxazone, benzfendizone, butafenacil, pyraclonil, profluazol, flufenpyr, flupropacil, nipyraclofen and etnipromid;
herbicides, such as metflurazon, norflurazon, flufenican, diflufenican, picolinafen, beflubutamid, fluridone, fluorochloridone, flurtamone, mesotrione, sulcotrione, isoxachlortole, isoxaflutole, benzofenap, pyrazolynate, pyrazoxyfen, benzobicyclon, amitrole, clomazone, aclonifen, 4-(3-trifluoromethylphenoxy)-2-(4-trifluoromethylphenyl)pyrimidine, and 3-heterocyclyl-substituted benzoyl derivatives of the formula (cf. WO-A-96/26202, WO-A-97/41116, WO-A-97/41117 and WO-A-97/41118)

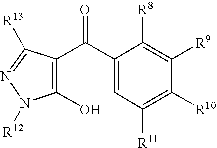

in which the substituents R⁸ to R¹³ have the following meanings:
R⁸, R¹⁰ are hydrogen, halogen, C₁-C₆-alkyl, C₁-C₆-haloalkyl, C₁-C₆-alkoxy, C₁-C₆-haloalkoxy, C₁-C₆-alkylthio, C₁-C₆-alkylsulfinyl or C₁-C₆-alkylsulfonyl;
R⁹ is a heterocyclic radical from the group consisting of thiazol-2-yl, thiazol-4-yl, thiazol-5-yl, isoxazol-3-yl, isoxazol-4-yl, isoxazol-5-yl, 4,5-dihydroisoxazol-3-yl, 4,5-dihydroisoxazol-4-yl and 4,5-dihydroisoxazol-5-yl, in which the classified radicals can carry one or more substituents, for example may be mono-, di-, tri- or tetrasubstituted by halogen, C₁-C₄-alkyl, C₁-C₄-alkoxy, C₁-C₄-haloalkyl, C₁-C₄-haloalkoxy or C₁-C₄-alkylthio;
R¹¹=hydrogen, halogen or C₁-C₆-alkyl;
R¹²=C₁-C₆-alkyl;
R¹³=hydrogen or C₁-C₆-alkyl.

Further suitable herbicides are EPSP synthase inhibitors such as glyphosate;

glutamine synthase inhibitors such as glufosinate and bilanaphos;
DHP synthase inhibitors such as asulam;
mitosis inhibitors such as benfluralin, butralin, dinitramine, ethalfluralin, fluchloralin, isopropalin, methalpropalin, nitralin, oryzalin, pendimethalin, prodiamine, profluralin, trifluralin, amiprofos-methyl, butamifos, dithiopyr, thiazopyr, propyzamide, tebutam, chlorthal, carbetamide, chlorbufam, chlorpropham and propham;
VLCFA inhibitors such as acetochlor, alachlor, butachlor, butenachlor, delachlor, diethatyl, dimethachlor, dimethenamid, dimethenamid-P, metazachlor, metolachlor, S-metolachlor, pretilachlor, propachlor, propisochlor, prynachlor, terbuchlor, thenylchlor, xylachlor, allidochlor, CDEA, epronaz, diphenamid, napropamide, naproanilide, pethoxamid, flufenacet, mefenacet, fentrazamide, anilofos, piperophos, cafenstrole, indanofan and tridiphan;
inhibitors for the biosynthesis of cellulose, such as dichlobenil, chlorthiamid, isoxaben and flupoxam;
herbicides such as dinofenat, dinoprop, dinosam, dinoseb, dinoterb, DNOC, etinofen and medinoterb;
auxin herbicides such as clomeprop, 2,4-D, 2,4,5-T, MCPA, MCPA thioethyl, dichlorprop, dichlorprop-P, mecoprop, mecoprop-P, 2,4-DB, MCPB, chloramben, dicamba, 2,3,6-TBA, tricamba, quinclorac, quinmerac, clopyralid, fluoroxypyr, picloram, triclopyr and benazolin;
auxin transport inhibitors such as naptalam, diflufenzopyr;
furthermore: benzoylprop, flamprop, flamprop-M, bromobutide, chlorflurenol, cinmethylin, methyldymron, etobenzanid, fosamine, metam, pyributicarb, oxaziclomefone, dazomet, triaziflam and methyl bromide.

The term “safeners” has the following meaning: it is known that, in some cases, better herbicide compatibility can be achieved through the combined application of herbicides with a specific effect with organic active compounds which themselves may have a herbicidal effect. In these cases, these compounds act as antidote or antagonist and, on account of the fact that they reduce and/or prevent damage of useful plants, are referred to as “safeners”.

The following list indicates possible safeners, but should not be limited to these:

benoxacor, cloquintocet, cyometrinil, dichlormid, dicyclonon, dietholate, fenchlorazole, fenclorim, flurazole, fluxofenim, furilazole, isoxadifen, mefenpyr, mephenate, naphthalic anhydride, 2,2,5-trimethyl-3-(dichloroacetyl)-1,3-oxazolidine (R-29148), 4-(dichloroacetyl)-1-oxa-4-azaspiro[4.5]decane (AD-67; MON 4660) and oxabetrinil.

The following list of compounds with a growth regulatory effect indicates possible active substances, but should not be limited to these:

1-naphthylacetamide, 1-naphthyl acetic acid, 2-naphthyloxy acetic acid, 3-CPA, 4-CPA, ancymidol, anthraquinone, BAP, butifos; tribufos, butralin, chlorflurenol, chlormequat, clofencet, cyclanilide, daminozide, dicamba, dikegulac sodium, dimethipin, chlorfenethol, etacelasil, ethephon, ethychlozate, fenoprop, 2,4,5-TP, fluoridamid, flurprimidol, flutriafol, gibberellic acid, gibberillin, guazatin, imazalil, indolylbutyric acid, indolyl acetic acid, karetazan, kinetin, lactidichlor-ethyl, maleic hydrazide, mefluidide, mepiquat-chlorid, naptalam, paclobutrazole, prohexadione calcium, quinmerac, sintofen, tetcyclacis, thidiazuron, triiodobezoic acid, triapenthenol, triazethan, tribufos, trinexapacethyl, uniconazole.

On the basis of the abovementioned Pickering emulsions it is possible to produce aqueous microcapsule solutions which can in turn be used for producing microporous films on carrier substances, through which agrochemical formulations with controlled active substance release are obtained.

The present invention thus comprises methods for producing a liquid formation comprising microcapsules consisting of a solid, polymeric shell and of a liquid core comprising solvent, and an agrochemical active substance dispersed or dissolved in the solvent, wherein a Pickering emulsion of the solvent in water type is produced in which
(i) an agrochemical active substance is dissolved or dispersed in the solvent droplets and
(ii) a polymer in particulate form is used as emulsifier,
   and the resulting Pickering emulsion
(a) is incubated at room temperature or
(b) is heated.

Here, the concentration of active substance is 0.1 to 40% (w/w), preferably 1 to 20% (w/w); the concentration of polymer is 0.5 to 30% (w/w), preferably 1 to 20%.

The water/solvent ratio is from 99:1 to 50:50, preferably from 90:10 to 70:30.

In this connection, incubation of the Pickering emulsion should be understood as meaning a rest time before any subsequent processing step in which the polymeric emulsifier particles form a film on the surface of the emulsion droplets to give a solid shell. Here, the Pickering emulsion can, for example, simply be left to stand or shaken or stirred. Optionally, the solution can also be heated, in which case the boiling temperature of the water phase and of the solvent phase must not be exceeded. Customary methods for increasing the boiling temperature, such as adding salts or increasing the pressure, can likewise optionally be used.

Solvents which can be used are any organic solvents which, in water, have a solubility of less than 50%, preferably less than 25%, particularly preferably less than 10%, very particularly preferably less than 10%, in an extremely preferred embodiment less than 5%.

Examples of suitable solvents are hydrophobic organic solvents such as mineral oils, alkyl aromatics and hydrocarbons, and also fatty acid esters or mixtures of the abovementioned solvents.

Typical examples of the hydrophobic organic solvent are Hisol SAS-296 (a mixture of 1-phenyl-1-xylethane and 1-phenyl-1-ethylphenylethane, trade name of Nippon Petroleum Company), Hisol SAS-LH (trade name of Nippon Petroleum Company), Shellsol A (trade name of Shell Chemical Corporation), Shellsol AB (trade name of Shell Chemical Corporation), Shellsol E (trade name of Shell Chemical Corporation), Shellsol R (trade name of Shell Chemical Corporation), Shellsol T (trade name of Shell Chemical Corporation), Shellsol D-70 (trade name of Shell Chemical Corporation), Cactus Solvent HP-MN (with 80% methylnaphthalene, trade name of Nikko Petrochemical Company), Cactus Solvent HP-DMN (with 80% dimethylnaphthalene, trade name of Nikko Petrochemical Company), Cactus Solvent P-100 (alkylbenzene with 9 to 10 carbon atoms, trade name of Nikko Petrochemical Company), Cactus Solvent P-150 (alkylbenzene, trade name of Nikko Petrochemical Company), Cactus Solvent P-180 (a mixture of methylnaphthalene and dimethylnaphthalene, trade name of Nikko Petrochemical Company), Cactus Solvent P-200 (a mixture of methylnaphthalene and dimethylnaphthalene, trade name of Nikko Petrochemical Company), Cactus Solvent P-220 (a mixture of methylnaphthalene and dimethylnaphthalene, trade name of Nikko Petrochemical Company), Cactus Solvent PAD-1 (dimethylmonoisopropylnaphthalene, trade name of Nikko Petrochemical Company), Solvesso 100 (aromatic hydrocarbon, trade name of ExxonMobil Chemical), Solvesso 150 (aromatic hydrocarbon, trade name of ExxonMobil Chemical), Solvesso 200 (aromatic hydrocarbon, trade name of ExxonMobil Chemical), Suwasol 100 (toluene, trade name of Maruzen Petroleum Company), Suwasol 200 (xylene, trade name of Maruzen Petroleum Company), Vinycizer 20 (tridecyl phthalate, trade name of Kao Corporation), Vinycizer 40 (isobutyl adipate, trade name of Kao Corporation), Vinycizer 50 (diisodecyl adipate, trade name of Kao Corporation), Vinycizer 85 (naphthalic acid dialkyl ester, trade name of Kao Corporation), Vinycizer 105 (didecyl naphthalate, trade name of Kao Corporation), Vinycizer 124 (naphthalic acid dialkyl ester, trade name of Kao Corporation), Excepal O-OL (octyl oleate, trade name of Kao Corporation), Excepal L-OL (lauryl oleate, trade name of Kao Corporation), Excepal OD-OL (octyldodecyl oleate, trade name of Kao Corporation), Toxanon PP-1000 (polyoxypropylene glycol, trade name of Sanyo Chemical Industries), Nikkol IPA-A (isopropyl myristate, trade name of Nikko Chemical Company), Nikkol IPA-EX (isopropyl myristate, trade name of Nikko Chemical Company), Teclean N-30 (trade name of Nippon Petroleum Company), Teclean N-32 (trade name of Nippon Petroleum Company), Teclean N-33 (trade name of Nippon Petroleum Company), Mineral oil 46P (trade name of Nichibeikoyu Company), Pesticidal Mineral Oil P (trade name of Nichibeikoyu Company), Pesticidal Oil H (trade name of Nichibeikoyu Company), Super Oil A (trade name of Nichibeikoyu Company), Super Oil B (trade name of Nichibeikoyu Company), Super Oil C (trade name of Nichibeikoyu Company), Super Oil D (trade name of Nichibeikoyu Company), Super Oil E (trade name of Nichibeikoyu Company), Super Oil F (trade name of Nichibeikoyu Company), Spindle Oil No. 1 (trade name of Nichibeikoyu Company), Spindle Oil No. 2 (trade name of Nichibeikoyu Company), Mineral Oil B (trade name of Nichibeikoyu Company), Mineral Oil C (trade name of Nichibeikoyu Company), Naphthesol M (naphthalene/isoparaffin/normal paraffin/aroma=75% or more/5-10%/10% or less/5% or less, trade name of Nippon Petrochemical Company), Isosol 300 (trade name of Nippon Petrochemical Company), Isosol 400 (trade name of Nippon Petrochemical Company), Exxol D80 (a mixture of paraffin and cycloparaffin, trade name of ExxonMobil Chemical), Exxol D10 (mixture of paraffin and cycloparaffin, trade name of ExxonMobil Chemical), Exxol D130 (mixture of paraffin and cycloparaffin, trade name of ExxonMobil Chemical), Exxol D160 (mixture of paraffin and cycloparaffin, trade name of ExxonMobil Chemical), Isopar E (kerosene, trade name of ExxonMobil Chemical), Isopar G (kerosene, trade name of ExxonMobil Chemical), Isopar H (kerosene, trade name of ExxonMobil Chemical), Isopar M (kerosene, trade name of ExxonMobil Chemical), Neo-Chiozol Isopar E (kerosene, trade name of Chuo Chemical Company), IP Solvent 2028 (isoparaffin oil, Idemitsu Petrochemical Company), IP Solvent 2835 (isoparaffin oil, Idemitsu Petrochemical Company), Naplex 38 (naphthalene oil, trade name of Mobil Petroleum Corporation), Whitelex 205 (trade name of Mobil Petroleum Corporation), Whitelex 207 (trade name of Mobil Petroleum Corporation), Whitelex 215 (trade name of ExxonMobil Chemical), Whitelex 247 (trade name of ExxonMobil Chemical), Whitelex 2210 (trade name of ExxonMobil Chemical), Whitelex 307 (trade name of ExxonMobil Chemical), Whitelex 309 (trade name of ExxonMobil Chemical) and Whitelex 326 (trade name of ExxonMobil Chemical) and Whitelex 335 (trade name of ExxonMobil Chemical).

Suitable esters are esters of aliphatic monocarboxylic acids, esters of aliphatic di- or tricarboxylic acids, C₁₀-C₂₂-fatty acid esters, vegetable triglycerides and vegetable oils.

Examples of esters of aliphatic monocarboxylic acids are aliphatic esters (such as methyl, ethyl, n-propyl, isopropyl, n-butyl, isobutyl, n-pentyl, isopentyl, neopentyl, n-hexyl, isohexyl, n-heptyl, isoheptyl, n-octyl, ethylhexyl, n-nonyl and isononyl esters) and aromatic esters (such as benzyl esters) of fatty acids, such as acetic acid (such as ethyl acetate and n-butyl acetate), caproic acid, caprylic acid, capric acid, a mixture of caprylic acid and capric acid, lauric acid, myristic acid, a mixture of lauric acid and myristic acid, palmitic acid, stearic acid, a mixture of palmitic acid and stearic acid, myristoleic acid, palmitoleic acid, oleic acid, linoleic acid or linolenic acid, or carboxylic acids with further functional groups, such as lactic acid (such as ethyl lactate, butyl lactate, ethylhexyl lactate or 1-methoxy-2-propyl acetate).

A preferred group of esters of aliphatic monocarboxylic acids are vegetable oils and animal oils. For the purposes of the present invention, vegetable oils includes oils from oil-producing plants, such as rapeseed oil, soybean oil, palm oil, sunflower oil, cotton oil, corn oil, linseed oil, coconut oil, thistle oil or ricinus oil. For the purposes of the present invention, the term “animal oils” includes, inter alia, oils from oil-producing animals, such as tallow oil. Other examples of monocarboxylic acid esters are the transesterification products of these oils, such as alkyl esters, such as rapeseed oil methyl ester, such as Radia 7961 (Fina Chemicals, Belgium), or rapeseed oil ethyl ester.

The vegetable oils are preferably esters of C₁₀-C₂₂- and preferably C₁₂-C₂₀-fatty acids. These C₁₀-C₂₂-fatty acid esters are, for example, esters of unsaturated or saturated C₁₀-C₂₂-fatty acids, in particular with an even number of carbon atoms, e.g. cis-erucic acid, isoerucic acid, lauric acid, palmitic acid, myristic acid, in particular C₁₈-fatty acids, such as stearic acid, linoleic acid or linolenic acid.

Examples of C₁₀-C₂₂-fatty acid esters are esters which are obtainable by reacting glycerol or glycol with C₁₀-C₂₂-fatty acid esters and are present, for example, in oils of oil-producing plants, and also C₁-C₂₀-alkyl C₁₀-C₂₂-fatty acid esters, as are obtainable, for example, by reacting glycerol or glycol C₁₀-C₂₂-fatty acid esters with C₁-C₂₀-alcohols (such as methanol, ethanol, propanol or butanol). The transesterification can take place by methods well known per se, as are described, for example, in Römps Chemie Lexikon, 9th Edition, Volume 2, page 1343, Thieme Verlag, Stuttgart.

As C₁-C₂₀-alkyl C₁₀-C₂₂-fatty acid esters, preference is given to methyl esters, ethyl esters, n-propyl esters, isopropyl esters, n-butyl esters, isobutyl esters, n-pentyl esters, isopentyl esters, neopentyl esters, n-hexyl esters, isohexyl esters, n-heptyl esters, isoheptyl esters, n-octyl esters, 2-ethylhexyl esters, n-nonyl esters, isononyl esters and dodecyl esters. As glycerol or glycol C₁₀-C₂₂-fatty acid esters, preference is given to the uniform or mixed glycerol or glycol esters of C₁₀-C₂₂-fatty acids, in particular of fatty acids with an even number of carbon atoms, such as cis-erucic acid, isoerucic acid, lauric acid, palmitic acid, myristic acid, in particular C₁₈-fatty acids, such as stearic acid, linoleic acid or linolenic acid.

Examples of esters of aromatic monocarboxylic acids are esters of benzoic acid (such as n-butyl benzoate, benzyl benzoate, decyl benzoate, dodecyl benzoate, hexyl benzoate, isostearyl benzoate, methyl benzoate, octadecyl benzoate, benzoic acid C₁₂-C₁₅-alkyl ester) or salicylic acid.

Examples of esters of aliphatic di- or tricarboxylic acid are esters of maleic acid (methyl ester, ethyl ester), diester or triester derivatives of adipic acid (such as diisopropyl adipate (such as Crodamol® DA (Croda Oleochemicals, UK), diisobutyl adipate), citric acid (such as tributyl citrate, tributyl acetyl citrate), glutaric acid, succinic acid (such as dibasic esters: a mixture of methyl adipate, methyl glutarate and methyl succinate) or sebacic acid (such as n-octyl sebacate).

Examples of esters of aromatic dicarboxylic acids are the phthalic acid esters (such as dimethyl phthalate, diethyl, phthalate, dibutyl phthalate or diisononyl phthalate).

Examples of vegetable oils as are used in the form of commercially available auxiliaries for oily formulations are, for example, based on rapeseed oil, such as Hasten® (Victorian Chemical Company, Australia, main constituent rapeseed oil ethyl ester), Actirob®B (Novance, France, main constituent rapeseed oil methyl ester), Rako-Binol® (Bayer AG, Germany, main constituent rapeseed oil), Renol® (Stefes, Germany, main constituent rapeseed oil methyl ester) or Stefes Mero® (Stefes, Germany, main constituent rapeseed oil methyl ester).

Examples of vegetable triglycerides are coconut oil, palm oil, palm kernel oil, sunflower oil, olive oil and the like.

Besides the use of one of the abovementioned esters as solvent, the use of two or more is also preferred (i.e. it is also possible to use mixtures of the above-mentioned esters).

The average diameter of the microcapsules is 0.1 to 500 μm, preferably 0.3 to 500 μm, particularly preferably 0.5 to 50 μm.

Examples of suitable polymers are polyolefins, such as polyethylene, polypropylene, polybutylene and polyisobutylene; vinyl polymers such as polyvinyl chloride, polyvinyl acetate, polystyrene, polyacrylonitrile, polyacrylates, polymethacrylates; polyacetals, such as polyoxymethylene; polyesters such as polyhydroxybutyric acid, polyhydroxyvaleric acid, polyalkylene terephthalates, polyalkylene adipate terephthalates, polybutylene adipate terephthalates; polyester amides; polyether amides; polyamides; polyimides; polyethers; polyether ketones; polyurethanes, polycarbonates, polylactids and epoxides, and also copolymers of ethylene/vinyl acetate, ethylene/(meth)acrylates, styrene/acrylonitrile, styrene/butadiene, styrene/butadiene/acrylonitrile, olefin/maleic anhydride.

Preferred polymers are, for example, polyesters. Particular preference is given to biodegradable polybutylene adipate terephthalates, as described in DE 4 440 858 (e.g. commercially available as Ecoflex® from BASF).

The present invention comprises aqueous microcapsule solutions comprising microcapsules consisting of a solid, polymeric shell and a liquid core comprising solvent, and an agrochemical active substance dispersed or dissolved in the solvent producible by one of the abovementioned methods.

The term “producible by one of the abovementioned methods” is synonymous with the term “prepared by one of the abovementioned methods”.

Customary auxiliaries may also be added to the aqueous microcapsule solutions.

Here, the concentration of auxiliaries is 0.1 to 10% (w/w), preferably 1 to 5%.

The term auxiliaries describes surface-active substances, such as wetting agents, tackifiers or dispersants, protective colloids, antifoaming agents, thickeners, antifreezes, bactericides and, in the case of seed material dressing formulations, if appropriate, adhesives and/or, if appropriate, dyes.

Suitable protective colloids are all protective colloids customary for the formulation of agrochemical active substances, i.e. in the present case all water-soluble polymers with amphiphilic character known to the person skilled in the art, such as, for example, proteins, denatured proteins, polysaccharides, hydrophobically modified starches, and synthetic polymers, preferably polyvinyl alcohol, polycarboxylates, polyalkoxylates, polyvinylamine, polyethyleneimine, polyvinylpyrrolidone and copolymers thereof.

Suitable emulsifiers are all nonionic, anionic and cationic dispersants customary for the formulation of agrochemical active substances. Examples are alkali metal, alkaline earth metal, ammonium salts of lignosulfonic acid, naphthalenesulfonic acid, phenolsulfonic acid, dibutylnaphthalenesulfonic acid, alkylarylsulfonates, alkyl sulfates, alkylsulfonates, fatty alcohol sulfates, fatty acids and sulfated fatty alcohol glycol ethers, also condensation products of sulfonated naphthalene and naphthalene derivatives with formaldehyde, condensation products of naphthalene or of naphthalenesulfonic acid with phenol and formaldehyde, polyoxyethylene octylphenol ether, ethoxylated isooctylphenol, octylphenol, nonylphenol, alkylphenol polyglycol ether, tributylphenyl polyglycol ether, tristerylphenyl polyglycol ether, alkyl aryl polyether alcohols, alcohol and fatty alcohol ethylene oxide condensates, ethoxylated ricinic oil, polyoxyethylene alkyl ether, ethoxylated polyoxypropylene, lauryl alcohol polyglycol ether acetal, sorbitol ester, lignosulfite spent liquors and methylcellulose.

Suitable thickeners which may be present in the formulations according to the invention are all thickeners customary for the formulation of agrochemical active substances. Examples of thickeners (i.e. compounds which impart pseudoplastic flow behavior to the formulation, i.e. high viscosity in the resting state and low viscosity in the moving state) are, for example, polysaccharides and organic layered minerals, such as xanthan gum (Kelzan® from Kelco), Rhodopol® 23 (Rhone Poulenc) or Veegum® (R.T. Vanderbilt) or Attaclay® (Engelhardt).

Suitable antifoams which may be a present in the formulations according to the invention are all antifoams customary for the formulation of agrochemical active substances. Examples of antifoams are silicone emulsions (such as, for example, Silikon® SRE, Wacker or Rhodorsil® from Rhodia), long-chain alcohols, fatty acids, organofluorine compounds and mixtures thereof.

Bactericides can be added for stabilizing aqueous formulations. Suitable bactericides which may be present in the formulations according to the invention are all bactericides customary for the formulation of agrochemical active ingredients, such as, for example, bactericides based on dichlorophene and benzyl alcohol hemiformal. Examples of bactericides are Proxel® from ICI or Acticide® RS from Thor Chemie and Kathon® MK from Rohm & Haas.

Suitable antifreezes which may be present in the formulations according to the invention are all antifreezes customary for the formulation of agrochemical active ingredients. Suitable antifreezes are, for example, ethylene glycol, propylene glycol or glycerol, preferably propylene glycol and glycerol.

Suitable dyes are all dyes customary for such purposes. In this connection, it is possible to use either pigments that are sparingly soluble in water, or dyes that are soluble in water. Examples which may be given are the dyes known under the names Rhodamin B, C.I. Pigment Red 112 and C.I. Solvent Red 1, and also pigment blue 15:4, pigment blue 15:3, pigment blue 15:2, pigment blue 15:1, pigment blue 80, pigment yellow 1, pigment yellow 13, pigment red 112, pigment red 48:2, pigment red 48:1, pigment red 57:1, pigment red 53:1, pigment orange 43, pigment orange 34, pigment orange 5, pigment green 36, pigment green 7, pigment white 6, pigment brown 25, basic violet 10, basic violet 49, acid red 51, acid red 52, acid red 14, acid blue 9, acid yellow 23, basic red 10, basic red 108.

Suitable adhesives which may be present in the formulations according to the invention are all binders that can customarily be used in dressings. Preferably, mention will be made of polyvinylpyrrolidone, polyvinyl acetate, polyvinyl alcohol and tylose.

The importance and corresponding use of the abovementioned agents is governed by the nature of the active substance.

The formulations with controlled active substance release can be produced by (process variant 1)
(a) applying a Pickering emulsion of the solvent in water type to a solid carrier by bringing the carrier into contact with the Pickering emulsion, where the Pickering emulsion
   (i) comprises solvent droplets, where an agrochemical active substance is dissolved or dispersed in the solvent droplets and
   (ii) a polymer in particulate form is used as emulsifier, and
(b) the mixture obtained in step (a) is incubated at room temperature or the mixture obtained in step (a) is heated; and
(c) the mixture obtained in step (b) is dried.

In an alternative method (process variant 2),
(a′) a microcapsule solution which is produced as detailed above can be admixed with a solid carrier; and
(b′) the mixture obtained in step (a′) is dried.

Here, a microcapsule solution prepared beforehand can be used.

Alternatively, the carrier can be introduced into a directly prepared microcapsule solution (process variant 3), where
(a″) a Pickering emulsion of the solvent in water type is prepared in which
   (i) an agrochemical active substance is dissolved or dispersed in the solvent droplets and
   (ii) a polymer in particulate form is used as emulsifier, and this emulsion is incubated or heated at room temperature;
(b″) the mixture obtained in step (a″) is admixed with a carrier; and
(c″) the mixture obtained in step (b″) is dried.

In this connection, the abovementioned auxiliaries can be added when preparing the Pickering emulsion and/or when preparing the microcapsules and/or when adding the carrier.

In a preferred embodiment, the method is carried out in accordance with process variant 2 or 3.

The abovementioned methods give formulations with a controlled active substance release.

The formulations comprise a carrier onto which a microporous film is applied, where active substance, which is dispersed or dissolved in a solvent, is located in the pores of the film.

Depending on the auxiliaries added in the method, added auxiliaries may also be present in the film or in the pores of the film.

The abovementioned formulations are provided by the present invention.

The carrier in the formulations according to invention may, for example, be a solid carrier substance, as is used for producing solid agrochemical formulations (such as, for example, dusts (DP) or granules (GR, FG, GG, MG)), seed material or a film, as is used for the cultivation of fruit and vegetables.

In a preferred embodiment, seed material or a solid carrier substance is used; very particularly preferably, a seed material is used.

Suitable solid carrier substances are, for example, mineral earths, such as silica gels, highly disperse silicas, silicates, talc, kaolin, attaclay, limestone, lime, chalk, bolus, loess, clay/clay earths, talc, dolomite, diatomaceous earth, calcium sulfate and magnesium sulfate, magnesium oxide, and ground plastics, fertilizers, such as, for example, ammonium sulfate, ammonium phosphate, ammonium nitrate, ureas and vegetable products, such as corn meal, bark dust, sawdust and nutshell meal, cellulose powder and other solid carrier substances.

The term seed material comprises seed material of all types, such as, for example, grians, seeds, fruits, tubers, seedlings and similar forms. Preferably, the term seed material here describes grains and seeds.

Suitable seed materials are cereal seeds, grain crop seeds, root crop seeds, oil seeds, vegetable seeds, spice seeds or ornamental plant seed material, e.g. seed material from hard wheat, wheat, barley, oats, rye, corn (fodder corn and sweetcorn), soybean, oil seeds, crucifers, cotton, sunflowers, bananas, rice, rape, turnips, sugar beet, fodder beet, egg plants, potatoes, grass, (cultivated lawns, fodder grass, tomatoes, leeks, pumpkins, cabbage, iceberg lettuce, peppers, cucumbers, melons, Brassica spp, melons, beans, peas, garlic, onions, carrots, tuberous plants such as sugarcane, tobacco, grapes, petunias and geraniums, pansies, touch-me-not, preferably wheat, corn, soybean and rice.

The seed material of transgenic plants or of plants obtained by conventional cultivation methods can also be used as seed material.

Thus, seed material may be used which is tolerant to herbicides, fungicides or insecticides, for example plants resistant to sulfonylureas, imidazolinones or glufonsinate or glyphosate (see, for example, EP-A-0242236, EP-A-242246) (WO 92/00377) (EP-A-0257993, U.S. Pat. No. 5,013,659) or in transgenic plants, e.g. cotton, which produce Bacillus thuringiensis toxin (Bt toxins) and are thereby resistant to certain harmful organisms (EP-A-0142924, EP-A-0193259).

In addition, use may also be made of seed material from plants which have modified properties compared with conventional plants. Examples thereof are modified starch synthesis (e.g. WO 92/11376, WO 92/14827, WO 91/19806) or fatty acid compositions (WO 91/13972).

In a further embodiment of the present invention, the seed material can be coated beforehand with an active substance-free polymer film. Suitable methods are known to the person skilled in the art. Thus, for example, WO 04/049778 describes a method in which, in a first step, the seed material is coated with an active substance-free polymer film before applying a dressing formulation.

As mentioned above, the solid carrier may also be a film. The films coated with the formulation according to the invention onto which a microporous film has been applied are preferably used in the cultivation of fruit and vegetables for covering the growing plants. Suitable film materials which can be coated with the formulation according to the invention are films made of polyethylene, polypropylene, polyesters, polyamides or others which are of sufficient thickness. Preferably, the active ingredient used here is an insecticide.

It the carrier used is a solid carrier substance or a film, the present invention comprises a method for controlling phytopathogenic fungi and/or undesired plant growth and/or undesired insect or mite infestation and/or for regulating the growth of plants, wherein the corresponding formulation is allowed to act on the particular pests (i.e. phytopathogenic fungi and/or undesired insects or mites), their habitat or the plants to be protected against the particular pest, the ground and/or on undesired plants and/or their habitat.

If the carrier used is seed material, the present invention comprises methods for controlling undesired insect or mite infestation on plants and/or for controlling phytopathogenic fungi and/or for controlling undesired plant growth, wherein seed materials of useful plants as described above are covered with a microporous film which comprises at least one agrochemical active substance.

In one embodiment of the abovementioned invention, if the active substance used is at least one herbicide, the seed material, prior to covering with the microporous film, is either covered with an active substance-free polymer film (see above) and/or the herbicide is used in combination with a safener, and/or use is made of seed material of plants which are resistant to the herbicide used.

The term phytopathogenic fungi describes, but is not limited to, the following species: Alternaria spp. on rice, vegetables, soybeans, rapeseed, sugar beet and fruits, Aphanomyces spp. on sugar beet and vegetables, Bipolaris and Drechslera spp. corn, cereals, rice and cultivated lawns, Blumeria graminis (powdery mildew) on cereals, Botrytis cinerea (gray mold) on strawberries, vegetables, cultivated flowers, grapes, Bremia lactucae on lettuce, Cercospora spp. on corn, soybeans and sugar beet, Cochliobolus spp. on corn, cereals, rice (e.g. Cochliobolus sativus on cereals, Cochliobolus miyabeanus on corn), Colletotrichum spp. on soybeans and cotton, Drechslera spp. on cereals and corn, Exserohilum spp. on corn, Erysiphe cichoracearum and Sphaerotheca fuliginea on cucumbers, Erysiphe necator on grapes, Fusarium and Verticillium spp. on various plants, Gaeumannomyces graminis on cereals, Gibberella spp. on cereals and rice (e.g. Gibberella fujikuroi on rice, Gibberella zeae on cereals), grainstaining complex on rice, Microdochium nivale on cereals, Mycosphaerella spp. on cereals, bananas and peanuts, Phakopsora pachyrhizi and Phakopsora meibomiae on soybeans, Phomopsis spp. on soybeans and sunflowers, Phytophthora infestans on potatoes and tomatoes, Plasmopara viticola on grapes, Podosphaera leucotricha on apples, Pseudocercosporella herpotrichoides on wheat and barley, Pseudoperonospora spp. on hops and cucumbers, Puccinia spp. on cereals and corn, Pyrenophora spp. on cereals, Pyricularia oryzae on rice, Cochliobolus miyabeanus and Corticium sasakii (Rhizoctonia solani), Fusarium semitectum (and/or moniliforme), Cercospora oryzae, Sarocladium oryzae, S. attenuatum, Entyloma oryzae, Gibberella fujikuroi (bakanae), grainstaining complex (various pathogens), Bipolaris spp., Drechslera spp. and Pythium and Rhizoctonia spp. on rice, corn, cotton, sunflowers, rapeseed (canola, oilseed rape), vegetables, cultivated lawns, nuts and other plants, Rhizoctonia solani on potatoes, Sclerotinia spp. on types of rapeseed (canola/oilseed rape) and sunflowers, Septoria tritici and Stagonospora nodorum on wheat, Uncinula necator on grapes, Sphacelotheca reiliana on corn, Thievaliopsis spp. on soybeans and cotton, Tilletia spp. on cereals, Ustilago spp. on cereals, corn, sugar beet and Venturia spp. (scab) on apples and pears.

The term undesired insects or mites describes, but is not limited to, the following genera:

Millipedes (Diplopoda), for example Blaniulus spp
Ants (Hymenoptera), for example Atta capiguara, Atta cephalotes, Atta laevigata, Atta robusta, Atta sexdens, Atta texana, Monomorium pharaonis, Solenopsis geminata, Solenopsis invicta, Pogonomyrmex spp and Pheidole megacephala,
Beetles (Coleoptera), for example Agrilus sinuatus, Agriotes lineatus, Agriotes obscurus and other Agriotes spp, Amphimallus solstitialis, Anisandrus dispar, Anthonomus grandis, Anthonomus pomorum, Aracanthus morei, Atomaria linearis, Blapstinus spp, Blastophagus piniperda, Blitophaga undata, Bothynoderes punciventris, Bruchus rufimanus, Bruchus pisorum, Bruchus lentis, Byctiscus betulae, Cassida nebulosa, Cerotoma trifurcata, Ceuthorrhynchus assimilis, Ceuthorrhynchus napi, Chaetocnema tibialis, Conoderus vespertinus and other Conoderus spp, Conorhynchus mendicus, Crioceris asparagi, Cylindrocopturus adspersus, Diabrotica (longicornis) barberi, Diabrotica semi-punctata, Diabrotica speciosa, Diabrotica undecimpunctata, Diabrotica virgifera and other Diabrotica spp, Eleodes spp, Epilachna varivestis, Epitrix hirtipennis, Eutinobothrus brasiliensis, Hylobius abietis, Hypera brunneipennis, Hypera postica, Ips typographus, Lema bilineata, Lema melanopus, Leptinotarsa decemlineata, Limonius californicus and other Limonius spp, Lissorhoptrus oryzophilus, Listronotus bonariensis, Melanotus communis and other Melanotus spp, Meligethes aeneus, Melolontha hippocastani, Melolontha melolontha, Oulema oryzae, Ortiorrhynchus sulcatus, Oryzophagus oryzae, Otiorrhynchus ovatus, Oulema oryzae, Phaedon cochleariae, Phyllotreta chrysocephala, Phyllophaga cuyabana and other Phyllophaga spp, Phyllopertha horticola, Phyllotreta nemorum, Phyllotreta striolata, and other Phyllotreta app, Popillia japonica, Promecops carinicollis, Premnotrypes voraz, Psylliodes spp, Sitona lineatus, Sitophilus granaria, Sternechus pinguis, Sternechus subsignatus, and Tanymechus palliatus and other Tanymechus spp,

Flies (Diptera), for example Agromyza oryzea, Chrysomya bezziana, Chrysomya hominivorax, Chrysomya macellaria, Contarinia sorghicola, Cordylobia anthropophaga, Dacus cucurbitae, Dacus oleae, Dasineura brassicae, Delia antique, Delia coarctata, Delia platura, Delia radicum, Fannia canicularis, Gasterophilus intestinalis, Geomyza tripunctata, Glossina morsitans, Haematobia irritans, Haplodiplosis equestris, Hypoderma lineata, Liriomyza sativae, Liriomyza trifolii, Lucilia caprina, Lucilia cuprina, Lucilia sericata, Lycoria pectoralis, Mayetiola destructor, Muscina stabulans, Oestrus ovis, Opomyza florum, Oscinella frit, Pegomya hysocyami, Phorbia antiqua, Phorbia brassicae, Phorbia coarctata, Progonya leyoscianii, Psila rosae, Rhagoletis cerasi, Rhagoletis pomonella, Tabanus bovinus, Tetanops myopaeformis, Tipula oleracea and Tipula paludosa,

Heteroptera (Heteroptera), for example Acrosternum hilare, Blissus leucopterus, Cicadellidae, for example Empoasca fabae, Chrysomelidae, Cyrtopeltis notatus, Delpahcidae, Dysdercus cingulatus, Dysdercus intermedius, Eurygaster integriceps, Euschistus impictiventris, Leptoglossus phyllopus, Lygus lineolaris, Lygus pratensis, Nephotettix spp, Nezara viridula, Pentatomidae, Piesma quadrata, Solubea insularis and Thyanta perditor,
Aphids and other homoptera, for example Acyrthosiphon onobrychis, Adelges laricis, Aphidula nasturtii, Aphis fabae, Aphis forbesi, Aphis glycines, Aphis gossypii, Aphis grossulariae, Aphis pomi, Aphis schneideri, Aphis spiraecola, Aphis sambuci, Acyrthosiphon pisum, Aulacorthum solani, Brachycaudus cardui, Brachycaudus helichrysi, Brachycaudus persicae, Brachycaudus prunicola, Brevicoryne brassicae, Capitophorus horni, Cerosipha gossypii, Chaetosiphon fragaefolii, Cryptomyzus ribis, Dreyfusia nordmannianae, Dreyfusia piceae, Dysaphis radicola, Dysaulacorthum pseudosolani, Dysaphis plantaginea, Dysaphis pyri, Empoasca fabae, Hyalopterus pruni, Hyperomyzus lactucae, Macrosiphum avenae, Macrosiphum euphorbiae, Macrosiphon rosae, Megoura viciae, Melanaphis pyrarius, Metopolophium dirhodum, Myzodes (Myzus) persicae, Myzus ascalonicus, Myzus cerasi, Myzus varians, Nasonovia ribis-nigri, Nilaparvata lugens, Pemphigus bursarius, Pemphigus populivenae, and other Pemphigus spp, Perkinsiella saccharicida, Phorodon humuli, Psyllidae, for example Psylla mali, Psylla piri and other Psylla spp, Rhopalomyzus ascalonicus, Rhopalosiphum maidis, Rhopalosiphum padi, Rhopalosiphum insertum, Sappaphis mala, Sappaphis mali, Schizaphis graminum, Schizoneura lanuginosa, Sitobion avenae, Trialeurodes vaporariorum, Toxoptera aurantiiand, and Viteus vitifolii; Lepidoptera, for example Agrotis ypsilon, Agrotis segetum and other Agrotis spp, Alabama argillacea, Anticarsia gemmatalis, Argyresthia conjugella, Autographa gamma, Bupalus piniarius, Cacoecia murinana, Capua reticulana, Chematobia brumata, Chilo suppresalis and other Chilo spp, Choristoneura fumiferana, Choristoneura occidentalis, Cirphis unipuncta, Cnaphlocrocis medinalis, Cydia pomonella, Dendrolimus pini, Diaphania nitidalis, Diatraea grandiosella, Earias insulana, Elasmopalpus lignosellus, Eupoecilia ambiguella, Euxoa spp, Evetria bouliana, Feltia subterranea, Galleria mellonella, Grapholitha funebrana, Grapholitha molesta, Heliothis armigera, Heliothis virescens, Heliothis zea, Hellula undalis, Hibernia defoliaria, Hyphantria cunea, Hyponomeuta malinellus, Keiferia lycopersicella, Lambdina fiscellaria, Laphygma exigua, Lerodea eufala, Leucoptera coffeella, Leucoptera scitella, Lithocolletis blancardella, Lobesia botrana, Loxostege sticticalis, Lymantria dispar, Lymantria monacha, Lyonetia clerkella, Malacosoma neustria, Mamestra brassicae, Momphidae, Orgyia pseudotsugata, Ostrinia nubilalis, Panolis flammea, Pectinophora gossypiella, Peridroma saucia, Phalera bucephala, Phthorimaea operculella, Phyllocnistis citrella, Pieris brassicae, Plathypena scabra, Plutella xylostella, Pseudoplusia includens, Rhyacionia frustrana, Scrobipalpula absoluta, Sesamia nonagrioides and other Sesamia spp, Sitotroga cerealella, Sparganothis pilleriana, Spodoptera frugiperda, Spodoptera littoralis, Spodoptera litura, Thaumatopoea pityocampa, Tortrix viridana, Trichoplusia ni and Zeiraphera canadensis,
Orthoptera, for example Acrididae, Acheta domestica, Blatta orientalis, Blattella germanica, Forficula auricularia, Gryllotalpa gryllotalpa, Locusta migratoria, Melanoplus bivittatus, Melanoplus femur-rubrum, Melanoplus mexicanus, Melanoplus sanguinipes, Melanoplus spretus, Nomadacris septemfasciata, Periplaneta americana, Schistocerca americana, Schistocerca peregrina, Stauronotus maroccanus and Tachycines asynamorus;
Termites (Isoptera), for example Calotermes flavicollis, Coptotermes spp, Dalbulus maidis, Leucotermes flavipes, Macrotermes gilvus, Reticulitermes lucifugus and Termes natalensis;
Thrips (Thysanoptera) for example Frankliniella fusca, Frankliniella occidentalis, Frankliniella tritici and other Frankliniella spp, Scirtothrips citri, Thrips oryzae, Thrips palmi, Thrips simplex and Thrips tabaci,
Arachnoidea, for example arachnids (Acarina), for example of the families Argasidae, Ixodidae and Sarcoptidae, for example Amblyomma americanum, Amblyomma variegatum, Argas persicus, Boophilus annulatus, Boophilus decoloratus, Boophilus microplus, Dermacentor silvarum, Hyalomma truncatum, Ixodes ricinus, Ixodes rubicundus, Ornithodorus moubata, Otobius megnini, Dermanyssus gallinae, Psoroptes ovis, Rhipicephalus appendiculatus, Rhipicephalus evertsi, Sarcoptes scabiei, and Eriophyidae spp, e.g. Aculus schlechtendali, Phyllocoptrata oleivora and Eriophyes sheldoni; Tarsonemidae spp, e.g. Phytonemus pallidus and Polyphagotarsonemus latus; Tenuipalpidae spp, e.g. Brevipalpus phoenicis; Tetranychidae spp, e.g. Tetranychus cinnabarinus, Tetranychus kanzawai, Tetranychus pacificus, Tetranychus telarius and Tetranychus urticae, Panonychus ulmi, Panonychus citri, and Oligonychus pratensis;
Nematodes, in particular plant parasitic nematodes, for example “root knot” nematodes, Meloidogyne hapla, Meloidogyne incognita, Meloidogyne javanica, and other Meloidogyne spp; cyst-forming nematodes, Globodera rostochiensis and other Globodera spp; Heterodera avenae, Heterodera glycines, Heterodera schachtii, Heterodera trifolii, and other Heterodera spp; seed gall nematodes, Anguina spp; stem and foliar nematodes, Aphelenchoides spp; sting nematodes, Belonolaimus longicaudatus and other Belonolaimus spp; pine nematodes, Bursaphelenchus xylophilus and other Bursaphelenchus spp; ring nematodes, Criconema spp, Criconemella spp, Criconemoides spp, Mesocriconema spp; stem and bulb nematodes, Ditylenchus destructor, Ditylenchus dipsaci and other Ditylenchus spp; Awl nematodes, Dolichodorus spp; spiral nematodes, Heliocotylenchus multicinctus and other Helicotylenchus spp; sheath and sheathoid nematodes, Hemicycliophora spp and Hemicriconemoides spp; Hirshmanniella spp; lance nematodes, Hoploaimus spp; false rootknot nematodes, Nacobbus spp; needle nematodes, Longidorus elongatus and other Longidorus spp; lesion nematodes, Pratylenchus neglectus, Pratylenchus penetrans, Pratylenchus curvitatus, Pratylenchus goodeyi and other Pratylenchus spp; burrowing nematodes, Radopholus similis and other Radopholus spp; reniform nematodes, Rotylenchus robustus and other Rotylenchus spp; Scutellonema spp; stubby root nematodes, Trichodorus primitivus and other Trichodorus spp, Paratrichodorus spp; stunt nematodes, Tylenchorhynchus claytoni, Tylenchorhynchus dubius and other Tylenchorhynchus spp; citrus nematodes, Tylenchulus spp; dagger nematodes, Xiphinema spp; and other plant parasitic nematodes.

Control of undesired plant growth means the control/destruction of plants which grow in places where they are undesired, for example

Dicotyledonous plants of the species: Sinapis, Lepidium, Galium, Stellaria, Matricaria, Anthemis, Galinsoga, Chenopodium, Urtica, Senecio, Amaranthus, Portulaca, Xanthium, Convolvulus, Ipomoea, Polygonum, Sesbania, Ambrosia, Cirsium, Carduus, Sonchus, Solanum, Rorippa, Rotala, Lindernia, Lamium, Veronica, Abutilon, Emex, Datura, Viola, Galeopsis, Papaver, Centaurea, Trifolium, Ranunculus, Taraxacum.
Monocotyledonous plants of the species: Echinochloa, Setaria, Panicum, Digitaria, Phleum, Poa, Festuca, Eleusine, Brachiaria, Lolium, Bromus, Avena, Cyperus, Sorghum, Agropyron, Cynodon, Monochoria, Fimbristyslis, Sagittaria, Eleocharis, Scirpus, Paspalum, Ischaemum, Sphenoclea, Dactyloctenium, Agrostis, Alopecurus, Apera.

### EXAMPLES

Example 1A film according to the invention of the biodegradable polymer polyethylene adipate terephthalate (Ecoflex®, BASF), which comprises the insecticide chlorpyrifos as active substance, was prepared in the following way:

153 mg of chlorpyrifos were dissolved in 6 ml of octanol. This solution was added to 34 ml of a 1% strength Ecoflex® dispersion which also comprises, as stabilizer, 0.125% of the anionic surfactant sodium dodecyl sulfate (SDS) and 0.125% of the sugar ester Ryoto S-1670S. Homogenization over 3 minutes using an ultra-turrax homogenizer (18 mm stirrer head, operated at 8000 rpm) gives a particle-stabilized octanol-in-water emulsion with a typical droplet size of between 1 and 15 μm in diameter. Scanning electron microscopy on a sample prepared by the freeze-fracture principle shows that the emulsion droplets are tightly surrounded by an absorbed layer of Ecoflex® particles.

The emulsion was then heated for 30 minutes at 60° C. and finally dried at 30-40° C., during which a solid film [of thickness about 0.05 mm] was left behind on the vessel floor.

Whereas some of the chlorpyrifos originally present in the emulsion droplets is now enclosed in the film, some is also located on the film surface.

### Determination of the Active Substance Content Inside the Film

For applications for the controlled release of active substance, it is useful to determine the active substance content enclosed in the film more specifically.

For this, 27.3 mg of a film charged with chlorpyrifos and prepared by the procedure described above were dissolved in 15 ml of tetrahydrofuran (THF), which is a good solvent both for the active substance and also for the polymer. 0.5 milliliters of this solution were further diluted to a volume of 20 ml with THF; a UV-vis spectrum was recorded for the dilute solution.

In a comparison experiment, the film was firstly washed in 15 ml of ethanol and dried before being analyzed as described above in a solution of THF by means of UV-vis spectroscopy.

Reference spectra were measured a series of THF solutions which, as well as 33.5 mg/l of Ecoflex® comprising Ecoflex® pellets, also comprised chlorpyrifos in concentrations of from 0 to 24 mg/l. A suitable comparison parameter which clearly reflects the chlorpyrifos content is the intensity ratio I₂/I₁ of characteristic peaks in the UV-vis spectrum at the wavelengths 244 nm and 290 nm.

An examination of these parameters for the spectra of the film prepared according to the invention and dissolved in THF, and of the film firstly washed in ethanol and then dissolved in THF shows that 24% of the chlorpyrifos used in the film preparation remains in the film even after washing with ethanol, whereas 76% of the active substance is washed away. This fraction, which can washed away with ethanol, is located on the film surface and is thus directly available in use whereas the enclosed fraction is only released in the course of film degradation, i.e. in a significantly delayed manner.

1-12. (canceled)

13. A method for producing a liquid formulation comprising microcapsules consisting of a solid, polymeric shell, a liquid core comprising solvent, and an agrochemical active substance dispersed or dissolved in the solvent, wherein a Pickering emulsion of the solvent in water type is produced in which
(i) an agrochemical active substance is dissolved or dispersed in the solvent droplets and
(ii) a polymer in particulate form is used as emulsifier, and the resulting Pickering emulsion
(a) is incubated at room temperature, or
(b) is heated.

14. The method of claim 13, wherein the average diameter of the microcapsules is 0.1 μm to 500 μm.

15. The method according to claim 13, wherein the polymer is a biodegradable polymer.

16. An aqueous microcapsule solution comprising microcapsules consisting of a solid, polymeric shell, a liquid core comprising solvent, and an agrochemical active substance dispersed or dissolved in the solvent produced by the method of claim 13.

17. A method for producing a formulation with controlled active substance release, comprising:
(a) applying a Pickering emulsion of the solvent in water type to a solid carrier, wherein
(i) the Pickering emulsion comprises solvent droplets in which an agrochemical active substance is dissolved or dispersed and
(ii) a polymer in particulate form is used as emulsifier, and
(b) incubating the mixture obtained in step (a) at room temperature or the mixture obtained in step (a) is heated; and
(c) drying the mixture obtained in step (b).

18. A formulation with controlled active substance release, comprising a carrier onto which a microporous film is applied by a method according to claim 17, an agrochemical active substance, which is dispersed or dissolved in a solvent, being located in the pores of the film.

19. The formulation according to claim 17, wherein the carrier is a solid carrier substance.

20. The formulation according to claim 19, wherein the carrier is seed material.

21. The formulation according to claim 19, wherein the carrier is seed material which has been coated with a polymer film.

22. The formulation according to claim 19, wherein the carrier is a film.

23. A method for controlling phytopathogenic fungi and/or undesired plant growth and/or undesired insect or mite infestation and/or for regulating the growth of plants, wherein a formulation according to claim 19 is applied to the particular pests (i.e. phytopathogenic fungi and/or undesired insects or mites), their habitat or the plants to be protected against the particular pest, the ground and/or on undesired plants and/or their habitat.

24. A method for controlling phytopathogenic fungi and/or undesired plant growth and/or undesired insect or mite infestation and/or for regulating the growth of plants, wherein a formulation according to claim 22 is applied the particular pests (i.e. phytopathogenic fungi and/or undesired insects or mites), their habitat or the plants to be protected against the particular pest, the ground and/or on undesired plants and/or their habitat.

25. A method for controlling undesired insect or mite infestation on plants and/or for controlling phytopathogenic fungi and/or for controlling undesired plant growth, wherein a microporous film is applied to the seed material of useful plants by a method according to claim 17, where an agrochemical active ingredient, dispersed or dissolved in a solvent, is located in the pores of the film.

26. A method for producing a formulation with controlled active substance release, comprising:
(a′) admixing a microcapsule solution consisting of a solid, polymeric shell, a liquid core comprising solvent, and an agrochemical active substance dispersed or dissolved in the solvent, wherein a Pickering emulsion of the solvent in water type is produced in which
(i) an agrochemical active substance is dissolved or dispersed in the solvent droplets and
(ii) a polymer in particulate form is used as emulsifier, and the resulting Pickering emulsion
(a) is incubated at room temperature, or
(b) is heated is admixed with a solid carrier; and
(b′) drying the mixture obtained in step (a′).

27. A formulation with controlled active substance release, comprising a carrier onto which a microporous film is applied by a method according to claim 26, an agrochemical active substance, which is dispersed or dissolved in a solvent, being located in the pores of the film.

28. The formulation according to claim 27, wherein the carrier is a solid carrier substance.

29. The formulation according to claim 28, wherein the carrier is seed material.

30. The formulation according to claim 28, wherein the carrier is seed material which has been coated with a polymer film.

31. The formulation according to claim 28, wherein the carrier is a film.

32. A method for controlling phytopathogenic fungi and/or undesired plant growth and/or undesired insect or mite infestation and/or for regulating the growth of plants, wherein a formulation according to claim 28 is applied to the particular pests (i.e. phytopathogenic fungi and/or undesired insects or mites), their habitat or the plants to be protected against the particular pest, the ground and/or on undesired plants and/or their habitat.

33. A method for controlling phytopathogenic fungi and/or undesired plant growth and/or undesired insect or mite infestation and/or for regulating the growth of plants, wherein a formulation according to claim 31 is applied to the particular pests (i.e. phytopathogenic fungi and/or undesired insects or mites), their habitat or the plants to be protected against the particular pest, the ground and/or on undesired plants and/or their habitat.

34. A method for controlling undesired insect or mite infestation on plants and/or for controlling phytopathogenic fungi and/or for controlling undesired plant growth, wherein a microporous film is applied to the seed material of useful plants by a method according to claim 26, where an agrochemical active ingredient, dispersed or dissolved in a solvent, is located in the pores of the film.

35. A method for producing a formulation with controlled active substance release, comprising:
(a″) a Pickering emulsion of the solvent in water type is produced in which
(i) an agrochemical active substance is dissolved or dispersed in the solvent droplets and
(ii) a polymer in particulate form is used as emulsifier, and this emulsion is incubated or heated at room temperature;
(b″) the mixture obtained in step (a″) is admixed with a carrier; and
(c″) the mixture obtained in step (b″) is dried.

36. A formulation with controlled active substance release, comprising a carrier onto which a microporous film is applied by a method according to claim 35, an agrochemical active substance, which is dispersed or dissolved in a solvent, being located in the pores of the film.

37. The formulation according to claim 36, wherein the carrier is a solid carrier substance.

38. The formulation according to claim 37, wherein the carrier is seed material.

39. The formulation according to claim 37, wherein the carrier is seed material which has been coated with a polymer film.

40. The formulation according to claim 37, wherein the carrier is a film.

41. A method for controlling phytopathogenic fungi and/or undesired plant growth and/or undesired insect or mite infestation and/or for regulating the growth of plants, wherein a formulation according to claim 37 is applied the particular pests (i.e. phytopathogenic fungi and/or undesired insects or mites), their habitat or the plants to be protected against the particular pest, the ground and/or on undesired plants and/or their habitat.

42. A method for controlling phytopathogenic fungi and/or undesired plant growth and/or undesired insect or mite infestation and/or for regulating the growth of plants, wherein a formulation according to claim 40 is applied the particular pests (i.e. phytopathogenic fungi and/or undesired insects or mites), their habitat or the plants to be protected against the particular pest, the ground and/or on undesired plants and/or their habitat.

43. A method for controlling undesired insect or mite infestation on plants and/or for controlling phytopathogenic fungi and/or for controlling undesired plant growth, wherein a microporous film is applied to the seed material of useful plants by a method according to claim 35, where an agrochemical active ingredient, dispersed or dissolved in a solvent, is located in the pores of the film.
